(19) United States
(12) Patent Application Publication
(10) Pub. No.: US 2011/0053658 A1
(43) Pub. Date: Mar. 3, 2011

(54) METHOD AND APPARATUS OF SLEEP MODE OPERATION IN MULTI-CARRIER SYSTEM

(75) Inventors: Giwon Park, Anyang-si (KR); Youngsoo Yuk, Anyang-si (KR); Yongho Kim, Anyang-si (KR); Kiseon Ryu, Anyang-si (KR)

(73) Assignee: LG Electronics Inc.

(21) Appl. No.: 12/872,636

(22) Filed: Aug. 31, 2010

Related U.S. Application Data
(60) Provisional application No. 61/239,031, filed on Sep. 1, 2009.
(60) Provisional application No. 61/239,047, filed on Sep. 1, 2009.

(30) Foreign Application Priority Data
Nov. 6, 2009 (KR) 10-2009-0107196

(51) Int. Cl. H04B 1/38

(52) U.S. Cl. 455/574

(57) ABSTRACT

Disclosed herein relates to a method and apparatus of establishing a sleep mode operation in a multi-carrier system. The method of establishing a sleep mode operation in a communication system of transmitting and receiving data using a multi-carrier including a primary carrier for transmitting and receiving control information and data and a secondary carrier using a radio frequency (RF) different from the primary carrier may include requesting a sleep mode switching to a base station through the primary carrier and receiving a sleep mode parameter including a sleep mode cycle and a listening window from the base station; entering into a multi-carrier sleep mode having a sleep cycle configured with a listening window capable of transmitting and receiving data and a sleep window incapable of transmitting and receiving data; transmitting a bandwidth request message to a base station through the primary carrier if data traffic to be is transmitted to the base station is generated in the multi-carrier sleep window;

changing a sleep mode cycle of the primary carrier to terminate the sleep window of the primary carrier and enter into a listening window; changing a sleep mode cycle of the secondary carrier to be identical to the changed sleep mode cycle of the primary carrier; and transmitting uplink data traffic to the base station during the listening window of the changed sleep mode cycle through the primary carrier and secondary carrier.

### RELATED APPLICATION

Pursuant to 35 U.S.C. §119(a), this application claims the benefits of earlier filing data and right of priority to U.S. Provisional Application Nos. 61/239,031 and 61/239,047, respectively filed on Sep. 1, 2009 and Sep. 1, 2009, and Korean Application No. 10-2009-0107196, filed on Nov. 6, 2009. The entire contents of these applications are herein fully incorporated by reference.

### BACKGROUND OF THE INVENTION

1. Field of the Invention

The present disclosure relates to a method and apparatus of establishing a sleep mode operation, and more particularly, to a method and apparatus of establishing a sleep mode operation in a multi-carrier system.

2. Description of the Related Art

With the development of the communication technology, services provided by a mobile communication system are being gradually developed into packet data transmission and/or reception services, multimedia broadcasting services, and the like, as well as voice communication services.

In the third generation services, such as WCDMA currently being serviced, high capacity data as well as voice can be transmitted and received at a high transmission rate, and furthermore, the standardization work is actively carried out, such as long-term evolution network (LTE), IEEE 802.16m, and the like, in order to make an evolved network having a wider bandwidth, considering a rapid increase of data traffic in the future.

In particular, IEEE 802.16m, for which its standardization work is carried out, has set a goal to develop a standard specification satisfying the requirement of an IMT-Advanced system while maintaining compatibility with existing 802.16-based terminals and base station equipment. In the IMT-Advanced system, above all, more than 40 MHz of broadband communication service support is required, and in IEEE 802.16m, broadband communication support is also essential to satisfy the requirement of the IMT-Advanced system. However, it is in fact difficult to define a standard for all bandwidths, and as a result, a communication system using a multi-carrier approach that supports broadband using a plurality of carriers is under discussion. In the multi-carrier system, discussed under IEEE 802.16m, it is possible to transmit and/or receive data between a terminal and a base station by accessing to each other through at least two and more frequency assignments (FAs) at the same time, and therefore, it has an advantage that high-capacity, high-speed data transmission and reception is possible compared to the existing single-carrier approaches. Also, it has a feature that communication is possible using a broader bandwidth from the standpoint of a mobile station (MS) depending on circumstances, and more users can be accommodated from the standpoint of a base station (BS).

On the other hand, since the mobility of terminals is considered in a wireless mobile communication system, the problem of power consumption in terminals may be a considerably important element compared to other systems. The sleep mode operation between a terminal and a base station has been proposed as one of such methods for minimizing power consumption in the terminal.

In the sleep mode operation in a single-carrier system, a terminal requests to enter into a sleep mode if there exists no more traffic to be transmitted and/or received to and/or from a base station while performing communication with the base station in an active mode, and receives a response to that request from the base station to change the state thereof to a sleep mode.

The terminal that has entered into a sleep state receives a message indicating whether there exists a traffic transferred from the base station during a sleep listening window, and determines that there exists no data traffic transmitted to a downlink, and increases the current sleep cycle if negative indication indicating that there exists no traffic is received.

Furthermore, if positive indication is received from the base station during the listening window, then the terminal determines that there exists data traffic transferred to a downlink, and initializes the current sleep cycle.

However, since multiple carriers are used in a multi-carrier system, the existing single-carrier system sleep mode operation cannot be applied thereto as it is, and thus there is a need for presenting sleep mode parameters for supporting more effective sleep mode operations in a multi-carrier environment, and a detailed sleep mode operation method in a multi-carrier system using the same.

### SUMMARY OF THE INVENTION

One aspect of the present disclosure is to provide a method and apparatus of establishing a sleep mode operation in a multi-carrier system.

In addition, another aspect of the present disclosure is to provide a method and apparatus of establishing a sleep mode operation in which if uplink data traffic is generated in a sleep window of multi-carrier, then a terminal requests a bandwidth to a base station through a primary carrier, and then receives secondary carrier information for data upload from the base station, thereby terminating a sleep window of the relevant secondary carrier and transmitting data traffic.

In order to accomplish the foregoing object, according to a first embodiment of the present invention, a method of performing (or establishing) a sleep mode operation in a communication system using a multi-carrier including a primary carrier and a secondary carrier for transmitting and receiving control information and data in which the secondary carrier uses a radio frequency (RF) different from the primary carrier, the method may include requesting a sleep mode switching to a base station through the primary carrier and receiving a sleep mode parameter including a sleep mode cycle and a listening window from the base station; entering into a multi-carrier sleep mode configured with a listening window capable of transmitting and receiving data and a sleep window incapable of transmitting and receiving data; transmitting a bandwidth request message to a base station through the primary carrier if data traffic to be transmitted to the base station is generated in the multi-carrier sleep window; changing a sleep mode cycle of the primary carrier to terminate the sleep window of the primary carrier and enter into a listening window; changing a sleep mode cycle of the secondary carrier to be identical to the changed sleep mode cycle of the primary carrier; and transmitting uplink data traffic to the base station during the listening window of the changed sleep mode cycle through the primary carrier and secondary carrier.

In order to accomplish the foregoing object, according to a second embodiment of the present invention, a method of performing (or establishing) a sleep mode operation in a communication system using a multi-carrier including a primary carrier and a secondary carrier for transmitting and receiving control information and data in which the secondary carrier uses a radio frequency (RF) different from the primary carrier, the method may include requesting a sleep mode switching to a base station through the primary carrier and receiving a sleep mode parameter including a sleep mode cycle and a listening window from the base station; allowing the sleep mode cycle of the multi-carrier to enter into a multi-carrier sleep mode configured with a listening window capable of transmitting and receiving data and a sleep window incapable of transmitting and receiving data; transmitting a bandwidth request message for transmitting the generated data traffic to the base station through the primary carrier if data traffic to be transmitted to the base station is generated in the multi-carrier sleep window;

interrupting the sleep window of the primary carrier and secondary carrier and entering into a listening window; transmitting uplink data traffic during the listening window of the primary carrier and secondary carrier; and terminating the listening window of the primary carrier and secondary carrier and returning (restoring) to a previous sleep mode cycle after (subsequent to) the completion of transmitting the uplink data traffic.

In order to accomplish the foregoing object, according to a third embodiment of the present invention, a method of performing (or establishing) a sleep mode operation in a communication system using a multi-carrier including a primary carrier and a secondary carrier for transmitting and receiving control information and data in which the secondary carrier uses a radio frequency (RF) different from the primary carrier, the method may include requesting a sleep mode switching to a base station through the primary carrier and receiving a sleep mode parameter including a sleep mode cycle and a listening window from the base station; allowing the sleep mode cycle of the multi-carrier to enter into a multi-carrier sleep mode configured with a listening window capable of transmitting and receiving data and a sleep window incapable of transmitting and receiving data; receiving, from the base station, through the primary carrier, an instruction for terminating data transmission over the secondary carrier in the listening window of the multi-carrier; terminating the listening window of the primary carrier and secondary carrier and entering into a sleep window; transmitting a bandwidth request message for transmitting the generated data traffic to a base station to the base station through the primary carrier if data traffic to be transmitted to the base station is generated in the sleep window of the primary carrier and secondary carrier; and terminating the sleep window of the primary carrier and secondary carrier and changing a sleep mode cycle using a sleep mode parameter of the primary carrier with respect to the primary carrier and the secondary carrier.

In order to accomplish the foregoing object, according to a fourth embodiment of the present invention, a method of performing (or establishing) a sleep mode operation in a communication system using a multi-carrier including a primary carrier and a secondary carrier for transmitting and receiving control information and data in which the secondary carrier uses a radio frequency (RF) different from the primary carrier, the method may include requesting a sleep mode switching to a base station through the primary carrier and receiving a sleep mode parameter including a sleep mode cycle and a listening window from the base station; allowing the sleep mode cycle of the multi-carrier to enter into a multi-carrier sleep mode configured with a listening window capable of transmitting and receiving data and a sleep window incapable of transmitting and receiving data; receiving, from the base station, through the primary carrier, an instruction for terminating data transmission over the secondary carrier in the listening window of the multi-carrier; terminating the listening window of the secondary carrier and entering into a sleep window; transmitting a bandwidth request message for transmitting the generated data traffic to a base station to the base station through the primary carrier if data traffic to be transmitted to the base station is generated; receiving a response message including secondary carrier information for transmitting uplink data traffic from the base station; terminating the sleep window of the secondary carrier and changing the sleep window of the secondary carrier to thereby be identical to the sleep mode cycle of the primary carrier; and transmitting the generated uplink data traffic through the primary carrier and secondary carrier.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view schematically illustrating a sleep mode operation;

FIG. 2 is a view schematically illustrating a multi-carrier system according to an embodiment of the present invention;

FIG. 3 is a view illustrating a method of controlling a sleep mode operation in a multi-carrier system according to a first embodiment of the present invention;

FIG. 4 is a view illustrating a method of controlling a sleep mode operation in a multi-carrier system according to a second embodiment of the present invention;

FIG. 5 is a view illustrating a method of controlling a sleep mode operation in a multi-carrier system according to a third embodiment of the present invention; and

FIG. 6 is a view illustrating a method of controlling a sleep mode operation in a multi-carrier system according to a fourth embodiment of the present invention.

### DETAILED DESCRIPTION OF THE INVENTION

Hereinafter, preferred embodiments of the present invention will be described in detail with reference to the accompanying drawings, and the same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings.

Hereinafter, the term “terminal” is used, but the terminal may be also referred to as a subscriber station (SS), user equipment (UE), mobile equipment (ME), and a mobile station (MS). Furthermore, the terminal may be portable equipment having a communication function such as portable phone, PDA, smart phone, notebook, etc., or non-potable equipment such as PC, vehicle mounted device, etc.

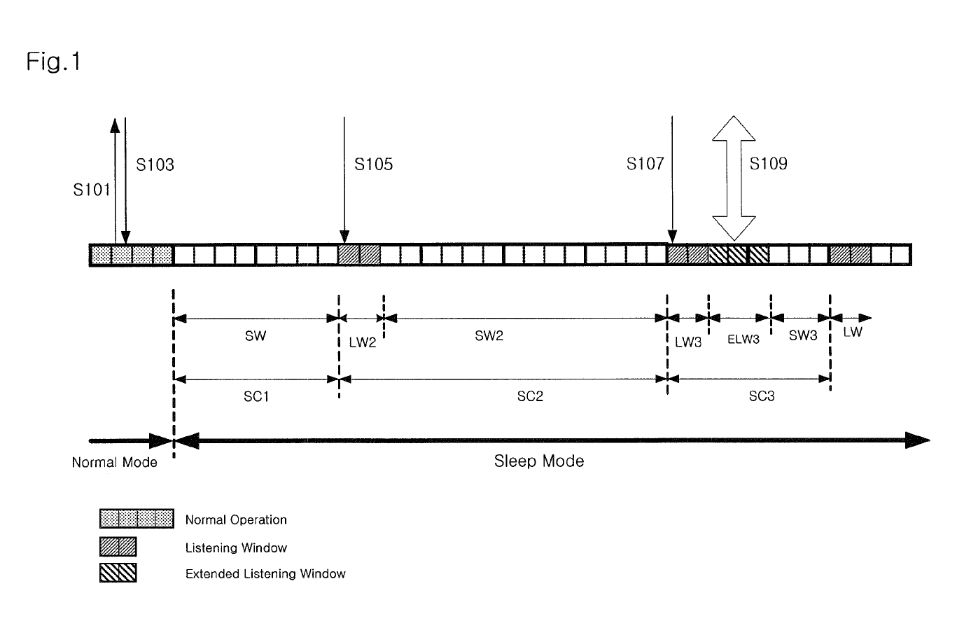

FIG. 1 is a view schematically illustrating a sleep mode operation in a single-carrier system.

A terminal transmits a SLP-REQ message for requesting to switch to a sleep mode to the base station if there exists no more traffic to be transmitted or received in a normal state (S101), and receives a SLP-RSP message including a sleep mode parameter such as sleep cycle, listening window, and the like from the base station (S103) to switch the state to a sleep mode.

The sleep mode may include a sleep window (SW) incapable of receiving data and a listening window (LW) capable of receiving data.

The terminal operates a sleep mode by applying a sleep cycle (SC1) including only a sleep window (SW1) when changing the state to an initial sleep mode. From a second sleep cycle subsequent to terminating the first sleep cycle (SC1), the terminal operates the sleep mode by applying a sleep cycle (SC2) including a listening window (LW2) and a sleep window (SW2).

In the second sleep cycle (SC2), if a TRF-IND message including negative indication is received from the base station during the listening window (LW2) (S105), then the terminal determines that there exists no data traffic transmitted to downlink, thereby increasing the current sleep cycle twice.

Subsequent to terminating the sleep cycle (SC2) increased twice, if a TRF-IND message including positive indication is received during a listening window (LW3) of the following sleep cycle (SC3) (S107), then the terminal extends the listening window (ELW3) to receive the generated data traffic and then receives data traffic from the base station (S109), and enters into a sleep window (SW3) again to perform a sleep mode operation. At this time, the sleep cycle (SC3) includes a listening window (LW3), an extended listening window (ELW3), and a sleep window (SW3) as illustrated in the drawing, and then the sleep cycle (SC3) is reset to an initial sleep cycle (SC1).

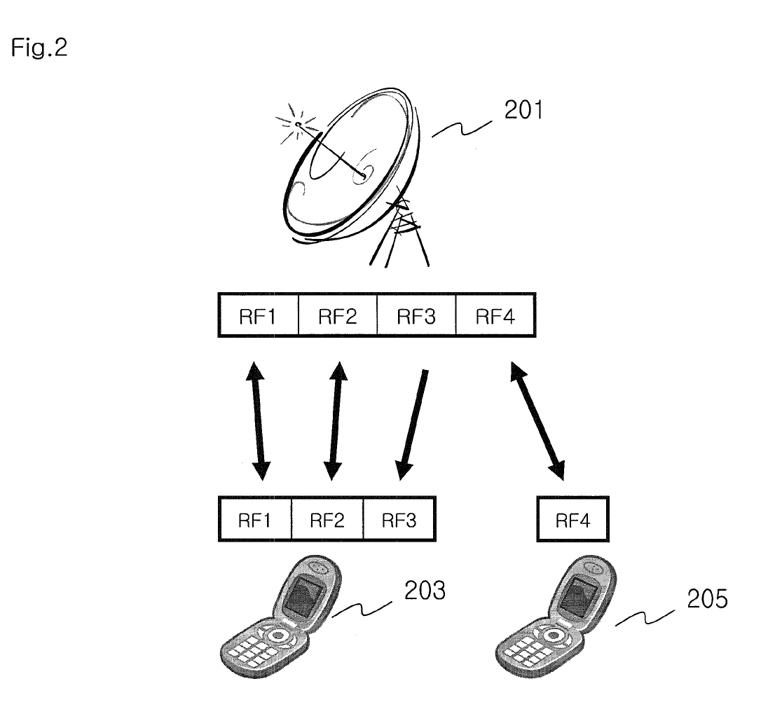

FIG. 2 is a view schematically illustrating a multi-carrier system according to an embodiment of the present invention;

As illustrated in FIG. 2, in a multi-carrier mode according to the present invention, the number of carriers allocated to terminals 203, 205 by a base station 201 to be used for data transmission and/or reception, or the like, may be at least two or more. According to an embodiment, for the sake of convenience of explanation, it will be described below a case where four carriers RF1, RF2, RF3 and RF4 are used. The base station 201 may allocate multiple carriers RF1, RF2, and RF3 for a terminal 203 to be used in a multi-carrier mode, and a carrier RF4 may be also allocated to another terminal 205 from the base station 201. In this case, the terminal 203 operates in a multi-mode by using one or more carriers, and the terminal 205 operates in a single-mode by using only one carrier.

In the base station 201, the multi-carrier type can be divided into two kinds of groups, a fully configured carrier (hereinafter, “FCC”), and a partially configured carrier (hereinafter, “FCC”). The fully configured carrier is defined as a carrier capable of transmitting and/or receiving uplink/downlink data and PHY/MAC control information, and the partially configured carrier as a carrier capable of transmitting downlink data and minimum control information to a terminal.

Referring to FIG. 2, RF1 and RF2, among the carriers allocated to the terminal 203, correspond to the fully configured carrier capable of transmitting and/or receiving uplink/downlink data and PHY/MAC control information of the terminal. RF3, allocated to the terminal 203, corresponds to the partially configured carrier capable of transmitting downlink data and some control information related to the data transmission from a base station to a terminal. The carrier RF4, allocated to the terminal 205, corresponds to the fully configured carrier capable of transmitting and/or receiving uplink/downlink data and terminal control information, and in case of a single-mode type such as the terminal 205, the carrier RF4 is preferably allocated in a fully configured carrier type since only one carrier RF4 is allocated.

From the standpoint of the terminals 203, 205, the types of carrier allocated from a base station can be divided into two kinds of groups, a primary carrier and a secondary carrier. Preferably, one primary carrier and a plurality of secondary carriers can be allocated to a terminal from a base station. According to the present invention, the primary carrier can transmit and/or receive data traffic and PHY/MAC control information between a terminal and a base station, and functions as a carrier mainly used for a control function such as network entry of a terminal. Furthermore, the secondary carrier can be additionally allocated to a terminal based upon a request of the terminal or a resource allocation command of the base station, and is used as a carrier for mainly transmitting and/or receiving data traffic.

Among the carriers allocated to the first terminal 203, RF1 or RF2 may become a primary carrier, and RF3 becomes a secondary carrier. Similarly, RF4, allocated to the second terminal 205, functions as a primary carrier. As illustrated in FIG. 2, in a multi-carrier system, it is possible to support the terminal 203 supporting a multi-carrier approach and the terminal 205 supporting a single-carrier approach only at the same time, and the terminal 203 supporting a multi-carrier approach can be also used as a single-mode using a single-carrier approach based upon data traffic. However, even if it is used as a multi-mode or single-mode, at least one carrier should be allocated. Here, the relevant carrier functions as a primary carrier when only one carrier is allocated.

The primary carrier of a terminal is a fully configured carrier defined by a base station, and a carrier that has performed an initial network entry procedure will be determined as a primary carrier. The secondary carrier can be set to a fully configured carrier or partially configured carrier, and it can be allocated additionally based upon a request or instruction of the terminal or base station. Preferably, the terminal can transmit and/or receive all control information and secondary carrier information through a primary carrier, and mainly receive information associated with downlink data transmission and reception through a secondary carrier.

Hereinafter, a method of controlling a sleep mode operation in a multi-carrier system as illustrated in FIG. 2 will be described in detail with reference to the related drawings.

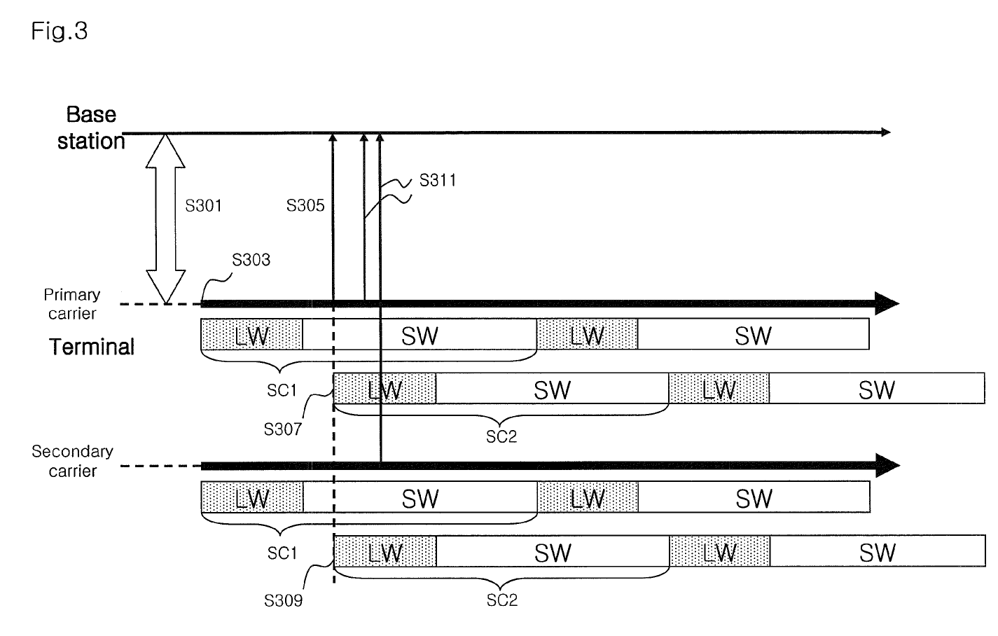

FIG. 3 is a view illustrating a method of controlling a sleep mode operation in a multi-carrier system according to a first embodiment of the present invention.

In this embodiment, a terminal receives multiple carriers allocated from the base station to be operated in a multi-mode, and the terminal may transmit and receive various control information and data through a primary carrier and transmits and receive data through a secondary carrier.

The terminal can transmit and receive data through uplink and downlink if the secondary carrier is a “fully configured carrier”, but the terminal may be used to receive data through downlink if the secondary carrier is a “partially configured carrier.”

In addition, the terminal performs a negotiation with the base station to perform a sleep mode switching request to the base station and a sleep mode operation through the primary carrier.

The terminal transmits a SLP-REQ message for requesting to switch to a sleep mode to the base station through the primary carrier if there exists no more traffic to be transmitted or received in a normal state, and receives a SLP-RSP message including a multi-carrier sleep mode parameter such as sleep cycle, listening window, and the like from the base station (S301).

The terminal refers to the received sleep mode parameter of SLP-RSP and switches the state to a sleep mode (S303).

According to circumstances, the base station may transmit an unsolicited SLP-RSP message to instruct the terminal to be switched to a sleep mode.

The sleep mode may include a sleep window (SW) incapable of receiving data and a listening window (LW) capable of receiving data, and the sleep cycle of multi-carriers including a primary carrier and a secondary carrier may include the listening window (LW) and the sleep window (SW) to constitute a sleep mode cycle (SC1) as illustrated in the drawing.

Then, if data traffic to be transmitted to the base station is generated in the sleep window (SW) of the primary carrier, then a bandwidth request message for transmitting the generated data traffic to the base station is transmitted to the base station through the primary carrier (S305).

The terminal requests bandwidth to the base station, and terminates the sleep window (SW) of the primary carrier to switch the state to the listening window (LW), and thus the sleep mode cycle of the primary carrier is also changed from SC1 to SC2 (S307).

Also, for uplink data transmission, the sleep mode cycle (SC1) of the secondary carrier is changed to be identical to the changed sleep mode cycle (SC2) of the primary carrier (S309).

The changed sleep mode cycle (SC1) of the secondary carrier may be changed to an initially allocated sleep mode cycle by referring to a sleep mode parameter of SLP-REQ/SLP-RSP transmitted and received from the base station when initially entering into the sleep mode. In other words, if bandwidth request is made, all activated carriers allocated to the terminal may change the sleep mode cycle to be operated with the sleep mode cycle allocated when initially entering into the sleep mode.

During the listening window (LW) of the changed sleep mode cycle (SC2), the terminal transmits uplink data traffic to the base station through the primary carrier and secondary carrier (S311).

In this embodiment, the activated secondary carriers is changed such that the sleep mode cycle is changed and applied to be identical to the sleep mode cycle of the primary carrier from the timing of bandwidth request.

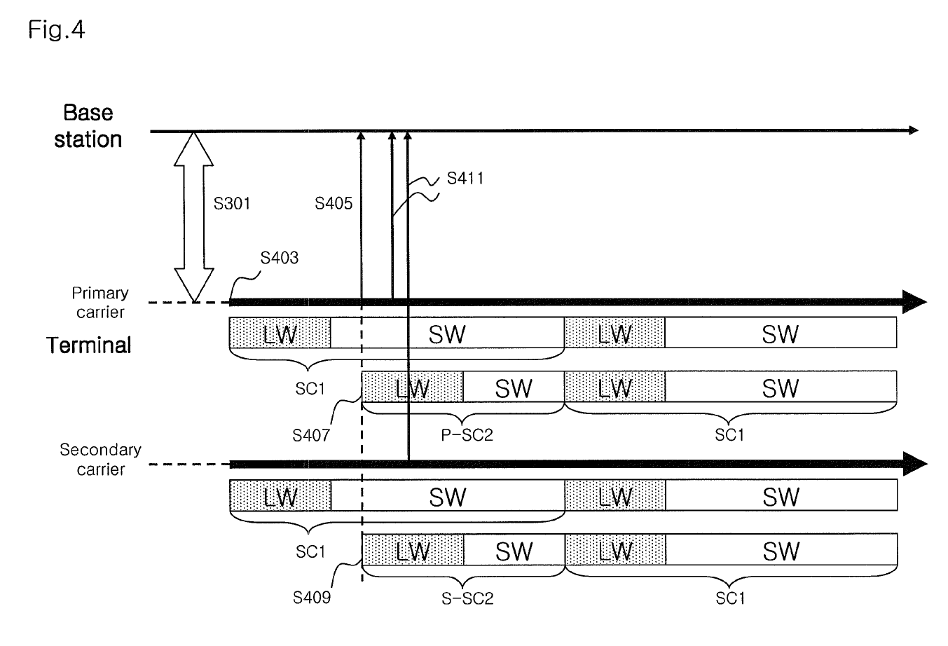

FIG. 4 is a view illustrating a method of controlling a sleep mode operation in a multi-carrier system according to a second embodiment of the present invention.

As illustrated with reference to FIG. 3, the terminal requests sleep mode switching to the base station, and receives a multi-carrier sleep mode parameter including a sleep mode cycle and a listening window from the base station (S301) to switch the state to a sleep mode (S403).

The sleep mode cycle (SC1) of a multi-carrier may include a listening window (LW) capable of transmitting and receiving data and a sleep window (SW) incapable of transmitting and receiving data.

If data traffic to be transmitted to the base station is generated in a multi-carrier sleep window, the terminal transmits a bandwidth request message for transmitting the generated data traffic to the base station through the primary carrier (S405).

Also, the sleep window of the primary carrier is interrupted to enter into a listening window (S407), and similarly, the sleep window of the secondary carrier is also interrupted to enter into a listening window (S409).

The interruption of the primary carrier and secondary carrier and the state change to a listening window is performed during a predetermined time window for transmitting data traffic.

Then, the terminal transmits the generated uplink data traffic to the base station through the primary carrier and secondary carrier during the listening window of the primary carrier and secondary carrier (S407).

If the transmission of the uplink data traffic is completed, then the listening window of the primary carrier is terminated and returned (restored) to a previous sleep mode cycle (SC1). At this time, if the previous sleep mode cycle is a sleep window (SW) when data transmission is completed, then the terminal enters into a sleep window.

Also, the sleep mode cycle of the secondary carrier is changed to be identical to the sleep mode cycle (SC1) of the primary carrier.

According to this embodiment, the terminal interrupts the sleep window (SW) at the timing of BW-REQ (S405) for a short while to be operated as a listening window (LW) until uplink data transmission is completed.

As a result, the base station recognizes that the sleep window of the terminal has been interrupted for a short while if the terminal make a bandwidth request for uplink data transmission, and returns (restores) to an original sleep window (SW) if the sleep window is still remained in the original sleep window subsequent to uplink data transmission.

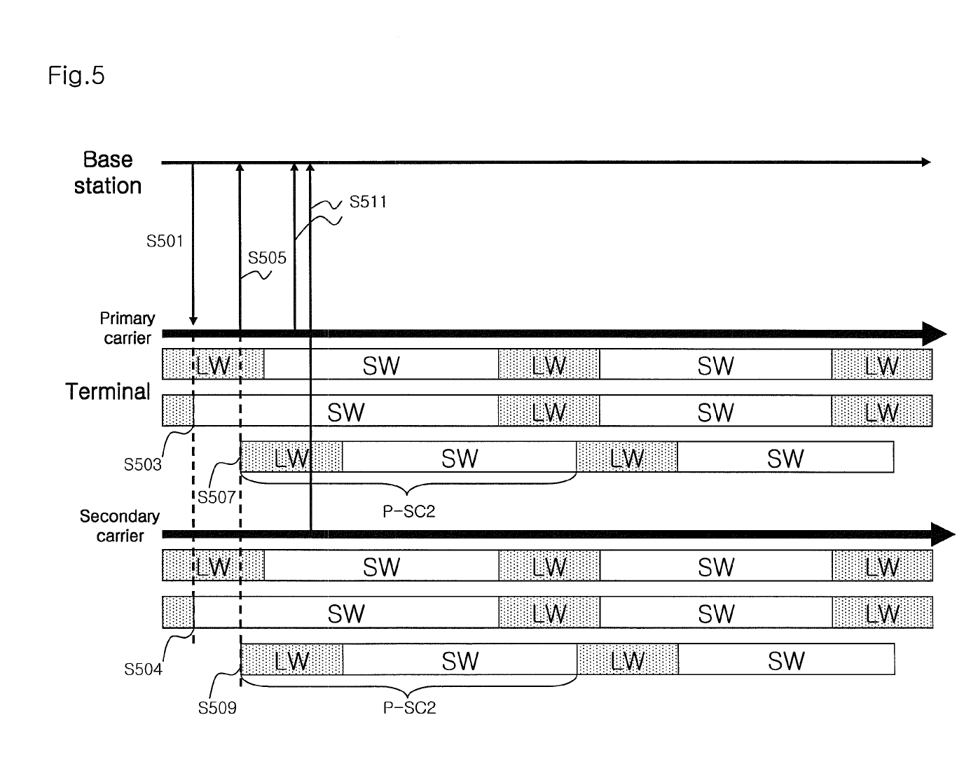

FIG. 5 is a view illustrating a method of controlling a sleep mode operation in a multi-carrier system according to a third embodiment of the present invention.

As illustrated with reference to FIG. 3 in the above, the terminal requests sleep mode switching to the base station, and receives a multi-carrier sleep mode parameter including a sleep mode cycle and a listening window from the base station (S301) to switch the state to a sleep mode.

The sleep mode cycle (SC1) of a multi-carrier may include a listening window (LW) capable of transmitting and receiving data and a sleep window (SW) incapable of transmitting and receiving data.

If there exists no more data traffic generated in the listening window in a multi-carrier sleep mode or the packet received from the base station is the last packet, then the base station may transmit an instruction message for early terminating the multi-carrier listening window to the terminal.

The terminal receives a listening window early termination instruction message from the base station through the primary carrier (S501), and the listening window early termination instruction message may be received through a sleep control extended header (SCEH).

An embodiment of SCEH is illustrated in Table 1.

TABLE 1

| | Size | |
|---|---|---|
| Syntax | (bit) | Notes |
| SCEH ( ) { | | |
| LAST | 1 | 0 = Another extended header follows SCEH |
| | | 1 = Another extended header does not follow SCEH |
| Type | — | SCEH Type |
| SCEH sub-type | 2 | 0b00 = Listening Window control |
| | | 0b01 = Resume Sleep Cycle Indication |
| | | 0b10 = Multi-Carrier Listening Window control |
| | | 0b11 = reserved |
| if (SCEH sub-type == Listening Window | | |
| Control) { | | |
| Listening Window End or Extension | 1 | 0 = Listening Window End Indication |
| | | 1 = Listening Window Extension Indication |
| Last frame of Extended Listening Window | 8 | The value is only valid with Listening |
| | | Window End or Extension is set to 1; |
| | | LSB of frame sequence. |
| | | Indicate the frame that extended |
| | | listening window is terminated; |
| } | | |
| Else if (SCEH sub-type == Resume Sleep | | |
| Cycle Indication) { | | |
| Scheduled Sleep Cycle Interruption | 1 | 0 = no scheduled Sleep Cycle |
| included | | interruption is included with the |
| | | Resume Sleep Cycle Indication |
| | | 1 = scheduled Sleep Cycle |
| | | interruption is included with the |
| | | Resume Sleep Cycle Indication |
| if (Scheduled Sleep Cycle Interruption | | |
| included == 1) { | | |
| Start Frame Offset for Scheduled Sleep | 8 | Number of frames in the future from |
| Cycle Interruption | | the frame containing this SCEH at |
| | | which the scheduled Sleep Cycle |
| | | interruption will occur. Frame offset is |
| | | value of this field plus one (i.e. range |
| | | is 1 to 256). |
| } | | |
| } | | |
| else if (SCEH sub-type == Multi-Carrier | | |
| Listening Window control) { | | |
| Listening Window End or Resume | 1 | 0 = Listening Window End Indication |
| | | 1 = Listening Window Resume Indication |
| if (Listening Window End or Resume == 0) { | | |
| Target Carrier Index | — | Carrier index of the target carrier on |
| | | which listening window ends |
| } | | |
| if (Listening Window End or Resume == 1) | | |
| Target Carrier Index | — | Carrier index of the target carrier on |
| | | which listening window resume |
| } | | |
| } | | |

The “Listening Window End or Resume” field in Table 1 is a value indicating the termination or restart of the listening window (LW) of a carrier, and the “Target Carrier Index” field corresponds to a bit value indicating a carrier index subject to the termination or restart of the listening window (LW) of a carrier.

Table 1 has a form of SCEH including listening window activation (LW Resume) as well as listening window termination (LW End), and as a result, listening window reactivation as well as listening window termination instruction is also possible.

Another form of SCEH is illustrated in the following Table 2, and there may exist only a function of terminating the listening window (LW) by including a target carrier index.

TABLE 2

| | | Size | |
|---|---|---|---|
| Syntax | | (bit) | Notes |
| SCEH ( ) { | | | |
| LAST | | 1 | 0 = Another extended header follows SCEH |
| | | | 1 = Another extended header does not follow SCEH |
| Type | | TBD | SCEH Type |
| SCEH sub-type | | 2 | 0b00 = Listening Window control |
| | | | 0b01 = Resume Sleep Cycle Indication |
| | | | 0b10 = Multi-Carrier Listening Window control |
| | | | 0b11 = reserved |
| if (SCEH sub-type == Listening Window Control) | | | |
| { | | | |
| Listening Window End or Extension | | 1 | 0 = Listening Window End Indication |
| | | | 1 = Listening Window Extension Indication |
| | Last frame of Extended Listening | 8 | The value is only valid with Listening |

| | | |
|---|---|---|
| Window | | Window End or Extension is set to 1; |
| | | LSB of frame sequence. |
| | | Indicate the frame that extended |
| | | listening window is terminated; |
| } | | |
| Else if (SCEH sub-type == Resume Sleep Cycle | | |
| Indication) { | | |
| Scheduled Sleep Cycle Interruption included | 1 | 0 = no scheduled Sleep Cycle |
| | | interruption is included with the |
| | | Resume Sleep Cycle Indication |
| | | 1 = scheduled Sleep Cycle interruption |
| | | is included with the Resume Sleep |
| | | Cycle Indication |
| if (Scheduled Sleep Cycle Interruption | | |
| included == 1) { | | |
| Start Frame Offset for Scheduled Sleep Cycle | 8 | Number of frames in the future from |
| Interruption | | the frame containing this SCEH at |
| | | which the scheduled Sleep Cycle |
| | | interruption will occur. Frame offset is |
| | | value of this field plus one (i.e. range is |
| | | 1 to 256). |
| } | | |
| } | | |
| else if (SCEH sub-type == Multi-Carrier | | |
| Listening Window control) { | | |
| Target Carrier Index(s) | — | Carrier index(s) of the target carrier |
| | | on which listening window ends |
| } | | |
| } | | |

Still another form of SCEH is illustrated in the following Table 3, and it has a feature that carrier index information specifying a listening window termination object of a carrier is not included therein.

The terminal received SCEH as illustrated in the following Table 3 may terminate the listening window (LW) of all activated carriers including the primary carrier and secondary carrier, and according to circumstances, may terminate the listening window (LW) of all activated secondary carrier excluding the primary carrier.

TABLE 3

| | | Size | |
|---|---|---|---|
| Syntax | | (bit) | Notes |
| SCEH ( ) { | | | |
| LAST | | 1 | 0 = Another extended header follows SCEH |
| | | | 1 = Another extended header does not follow SCEH |
| Type | | TBD | SCEH Type |
| SCEH sub-type | | 2 | 0b00 = Listening Window control |
| | | | 0b01 = Resume Sleep Cycle Indication |
| | | | 0b10 = Multi-Carrier Listening Window control |
| | | | 0b11 = reserved |
| if (SCEH sub-type == Listening Window Control) | | | |
| { | | | |
| Listening Window End or Extension | | 1 | 0 = Listening Window End Indication |
| | | | 1 = Listening Window Extension Indication |
| | Last frame of Extended Listening | 8 | The value is only valid with Listening |

| | | |
|---|---|---|
| Window | | Window End or Extension is set to 1; |
| | | LSB of frame sequence. |
| | | Indicate the frame that extended |
| | | listening window is terminated; |
| } | | |
| Else if (SCEH sub-type == Resume Sleep Cycle | | |
| Indication) { | | |
| Scheduled Sleep Cycle Interruption included | 1 | 0 = no scheduled Sleep Cycle |
| | | interruption is included with the |
| | | Resume Sleep Cycle Indication |
| | | 1 = scheduled Sleep Cycle interruption |
| | | is included with the Resume Sleep |
| | | Cycle Indication |
| if (Scheduled Sleep Cycle Interruption | | |
| included == 1) { | | |
| Start Frame Offset for Scheduled Sleep Cycle | 8 | Number of frames in the future from |
| Interruption | | the frame containing this SCEH at |
| | | which the scheduled Sleep Cycle |
| | | interruption will occur. Frame offset is |
| | | value of this field plus one (i.e. range is |
| | | 1 to 256). |
| } | | |
| } | | |
| else if (SCEH sub-type == Multi-Carrier | | |
| Listening Window control) { | | |
| Listening Window End | 1 | Termination of active carriers' LW |
| } | | |
| } | | |

The terminal received a listening window early termination instruction of a multi-carrier from the base station through any one form of SCEH among Tables 1, 2, and 3, terminates the listening window (LW) of a carrier specified through carrier index information or terminates the listening window (LW) of all carriers to switch the state to a sleep window.

If the SCEH corresponding to an instruction for terminating the listening window of all activated carriers as illustrated in Table 3 is received, then the terminal terminates the listening window of the primary carrier and enters into a sleep window (SW) (S503).

Similarly, the listening window (LW) of the secondary carrier is early terminated and the state is changed to a sleep window (SW) (S504).

On the other hand, if data traffic to be transmitted to the base station in the sleep window of the primary carrier and secondary carrier is generated, then the terminal transmits a bandwidth request message for transmitting the generated data traffic to a base station through the primary carrier to the base station (S505).

In addition, the terminal terminates the sleep window of the primary carrier to enter into the listening window from the timing of sending the bandwidth request message (S507), thereby changing the primary carrier sleep cycle to P-SC2 (S507).

The changed sleep mode cycle (P-SC2) of the primary carrier is changed such that a sleep mode cycle previously received from the base station from a start frame entering into the listening window is applied thereto.

At this time, the sleep mode cycle of the secondary carrier is changed to be identical to the changed sleep mode cycle (P-SC2) of the primary carrier (S509).

Then, the terminal transmits uplink data traffic to the base station during the listening window of the changed sleep mode cycle (P-SC2) of the primary carrier and secondary carrier (S509).

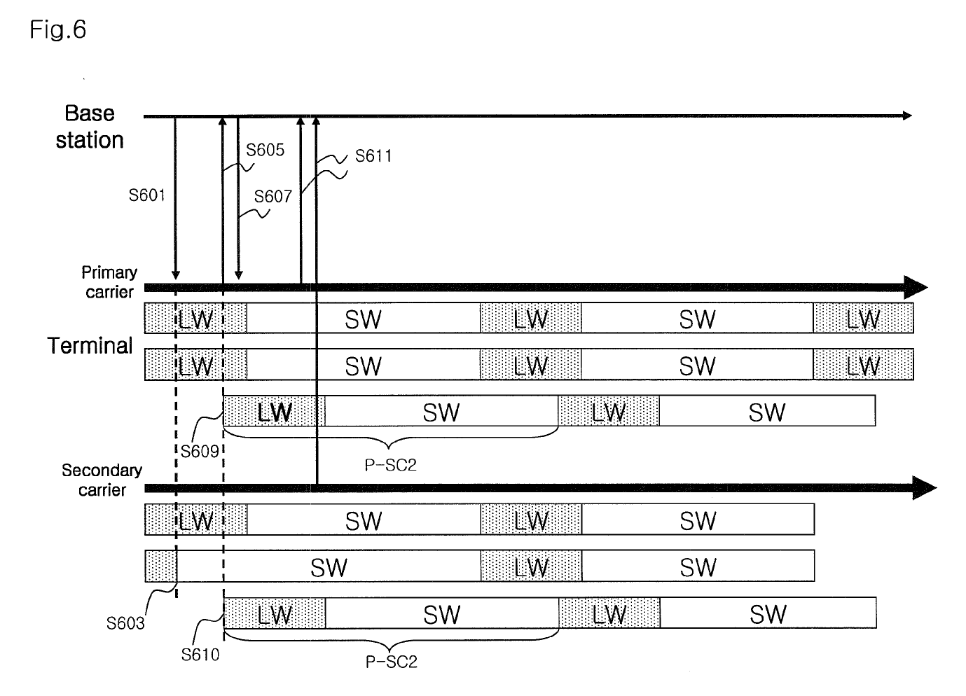

FIG. 6 is a view illustrating a method of controlling a sleep mode operation in a multi-carrier system according to a fourth embodiment of the present invention.

As illustrated with reference to FIG. 3 in the above, the terminal requests sleep mode switching to the base station, and receives a multi-carrier sleep mode parameter including a sleep mode cycle and a listening window from the base station (S301) to switch the state to a sleep mode.

The sleep mode cycle (SC1) of a multi-carrier may include a listening window (LW) capable of transmitting and receiving data and a sleep window (SW) incapable of transmitting and receiving data.

If there exists no more data traffic generated in the listening window in a multi-carrier sleep mode or the packet received from the base station is the last packet as illustrated in FIG. 5, then the base station may transmit an instruction message for early terminating the multi-carrier listening window to the terminal.

At this time, contrary to FIG. 5, in this embodiment, the listening window termination of all carriers may not be instructed but the listening window early termination of a specific secondary carrier may be instructed.

The terminal receives a listening window early termination instruction message of the specific secondary carrier from the base station through the primary carrier (S601), and the listening window early termination instruction message may be received through a sleep control extended header (SCEH) in the form of Table 1 or 2.

If an instruction for terminating the listening window of the secondary carrier is received from the base station in the listening window of the primary carrier, then the terminal maintains the listening window of the primary carrier and terminates the listening window of the secondary carrier and enters into a sleep window (S603).

Then, if data traffic to be transmitted to the base station is generated, then the terminal transmits a bandwidth request message for transmitting the generated data traffic to a base station through the primary carrier to the base station (S605).

In order to allow the terminal to transmit uplink data traffic through the secondary carrier when the terminal transmits the uplink data traffic, the base station may instruct a state change of the secondary carrier currently in a sleep window (SW) state.

The terminal receives a response message including secondary carrier information for uplink data traffic transmission (S607).

The response message may be received in the form of an unsolicited SLP-RSP message including a specific carrier index, or may be received through SCEH as illustrated in Table 1.

The terminal received the message refers to a specific carrier index of the message to change the state, thereby terminating the sleep window (SW) of the relevant secondary carrier and entering into a listening window (LW) (S610).

The unsolicited SLP-RSP message including a specific carrier index may be illustrated in the following Table 4.

TABLE 4

| | Size | |
|---|---|---|
| Syntax | (bit) | Notes |
| SLP-RSP_message_format( ) { | | |
| Management Message Type = X+1 | 8 | |
| Response_Code | 2 | 0b00: Request by BS in Unsolicited manner |
| | | 0b01: Approval of SLP-REQ |
| | | 0b10: Rejection of SLP-REQ |
| | | 0b11: Reserved |
| if(Response_Code != 0b10) { | | |
| Operation | 2 | 0b00: Exit Sleep Mode |
| | | 0b01: Enter Sleep Mode |
| | | 0b10: Change Sleep Mode |
| | | 0b11: Switch Sleep Cycle setting |
| if(Operation != 0b00) { | | |
| for(j=0; j< Num_Positive_SCIDs; j++) { | | |
| Carrier index | TBD | Carrier index for activation |
| } | | |
| if(Operation != 0b11) { | | |
| TIMF | 1 | 0: Traffic Indication via TRF-IND |
| | | message is disabled |
| | | 1: Traffic Indication via TRF-IND |
| | | message is enabled |
| Listening window Extension Flag (LWEF) | 1 | If LWEF = 0, the Listening window is of |
| | | fixed duration. |
| | | If LWEF = 1, the Listening window can |
| | | be extended and is of variable duration |
| | | In case of TIMF = 1, LWEF shall be set to 1 |
| Start_Frame_Number | 6 | Least Significant 6 bits of Frame |
| | | Number |
| Initial Sleep Cycle | 8 | |
| Final Sleep Cycle | 10 | |
| Listening Window | 6 | |
| if(TIMF == 1) { | | |
| SLPID | 10 | |
| }// End of if (TIMF == 1) | | |
| If(LWEF == 1) { | | |
| T_MS | 4 | Measured in Frames |
| T_HARQ_Retx | 4 | Measured in Frames |
| } // End of if (LWEF == 1) | | |
| } //End of if(Operation != 0b11) | | |
| }//End of if (Operation != 0b00) | | |
| }// End of if(Response_Code != 0b10) | | |
| else { | | |
| REQ_duration | 8 | Least Significant 8 bits of Frame |
| | | Number |
| } | | |
| Padding | variable | Padding bits to ensure byte aligned. |
| }//End of AAI_SLP-RSP | | |

The terminal receives an unsolicited SLP-RSP message as illustrated in Table 4 from the base station (S607), and terminates the sleep window (SW) of the secondary carrier and changes the sleep cycle of the secondary carrier to be identical to the sleep mode cycle of the primary carrier (S610).

Then, the generated uplink data traffic is transmitted to the base station through the primary carrier and secondary carrier (S611).

The method according to the present invention as described above may be implemented by software, hardware, or a combination of both. For example, the method according to the present invention may be stored in a storage medium (for example, an internal memory of the terminal, flash memory, hard disk, and so on), and may be implemented by codes or instructions within a software program that can be performed by a processor (for example, a microprocessor within the terminal).

Though preferred embodiments of present invention are exemplarily described as disclosed above, the scope of the invention is not limited to those specific embodiments, and thus various modifications, variations, and improvements can be made in the present invention without departing from the spirit of the invention, and within the scope of the appended claims.

What is claimed is:

1. A method of performing a sleep mode operation in a communication system using a multi-carrier including a primary carrier and a secondary carrier for transmitting and receiving control information and data in which the secondary carrier uses a radio frequency (RF) different from the primary carrier, the method comprising:
requesting a sleep mode switching to a base station through the primary carrier and receiving, from the base station, a sleep mode parameter including a sleep mode cycle and a listening window;
allowing the sleep mode cycle to enter into a multi-carrier sleep mode configured with a listening window capable of transmitting and receiving data and a sleep window incapable of transmitting and receiving data;
if data traffic to be transmitted to the base station is generated in the multi-carrier sleep window, transmitting, to the base station, a bandwidth request message for transmitting the generated data traffic to the base station through the primary carrier;
changing a sleep mode cycle of the primary carrier to terminate the sleep window of the primary carrier and to enter into a listening window;
changing a sleep mode cycle of the secondary carrier to thereby be identical to the changed sleep mode cycle of the primary carrier; and
transmitting uplink data traffic to the base station during the listening window of the changed sleep mode cycle through the primary carrier and secondary carrier.

2. The method of claim 1, wherein the secondary carrier is a full configured carrier capable of transmitting and receiving data through downlink and uplink.

3. The method of claim 1, wherein said changing the sleep mode cycle of the primary carrier and secondary carrier is characterized in that the sleep mode cycle of the primary carrier previously received from the base station is applied from a start frame of the listening window initially entered subsequent to the terminated sleep window

4. A method of performing a sleep mode operation in a communication system using a multi-carrier including a primary carrier and a secondary carrier for transmitting and receiving control information and data in which the secondary carrier uses a radio frequency (RF) different from the primary carrier, the method comprising:
requesting a sleep mode switching to a base station through the primary carrier and receiving a sleep mode parameter including a sleep mode cycle and a listening window from the base station;
allowing the sleep mode cycle to enter into a multi-carrier sleep mode configured with a listening window capable of transmitting and receiving data and a sleep window incapable of transmitting and receiving data;
if data traffic to be transmitted to the base station is generated in the multi-carrier sleep window, transmitting, to the base station, a bandwidth request message for transmitting the generated data traffic to the base station through the primary carrier;
interrupting the sleep window of the primary carrier and secondary carrier and entering into a listening window;
transmitting uplink data traffic during the listening window of the primary carrier and secondary carrier; and
terminating the listening window of the primary carrier and secondary carrier and returning to a previous sleep mode cycle after completion of transmitting the uplink data traffic.

5. The method of claim 4, wherein the secondary carrier is a full to configured carrier capable of transmitting and receiving data through downlink and uplink.

6. A method of performing a sleep mode operation in a communication system using a multi-carrier including a primary carrier and a secondary carrier for is transmitting and receiving control information and data in which the secondary carrier uses a radio frequency (RF) different from the primary carrier, the method comprising:
requesting a sleep mode switching to a base station through the primary carrier and receiving a sleep mode parameter including a sleep mode cycle and a listening window from the base station;
allowing the sleep mode cycle to enter into a multi-carrier sleep mode configured with a listening window capable of transmitting and receiving data and a sleep window incapable of transmitting and receiving data;
receiving, from the base station, through the primary carrier, an instruction for terminating data transmission over the secondary carrier in the listening window of the multi-carrier;
terminating the listening window of the primary carrier and secondary carrier and entering into a sleep window;
if data traffic to be transmitted to the base station is generated in the sleep window of the primary carrier and secondary carrier, transmitting, to the base station, a bandwidth request message for transmitting the generated data traffic to the base station through the primary carrier; and
terminating the sleep window of the primary carrier and secondary carrier and changing a sleep mode cycle using a sleep mode parameter of the primary to carrier with respect to the primary carrier and the secondary carrier.

7. The method of claim 6, wherein the instruction for terminating the listening window of the multi-carrier is received through a sleep control extended header.

8. The method of claim 6, wherein the secondary carrier is a full configured carrier capable of transmitting and receiving data through downlink and uplink.

9. The method of claim 6, wherein said changing the sleep mode cycle of the primary carrier and secondary carrier is characterized in that the sleep mode cycle of the primary carrier previously received from the base station is applied from a start frame of the listening window initially entered subsequent to the terminated sleep window.

10. A method of performing a sleep mode operation in a communication system using a multi-carrier including a primary carrier and a secondary carrier for transmitting and receiving control information and data in which the secondary carrier uses a radio frequency (RF) different from the primary carrier, the method comprising:
requesting a sleep mode switching to a base station through the primary carrier and receiving a sleep mode parameter including a sleep mode cycle and a listening window from the base station;
allowing the sleep mode cycle to enter into a multi-carrier sleep mode to configured with a listening window capable of transmitting and receiving data and a sleep window incapable of transmitting and receiving data;
receiving, from the base station, through the primary carrier, an instruction for terminating data transmission over the secondary carrier in the listening window of the multi-carrier
terminating the listening window of the secondary carrier and entering into a sleep window;
if data traffic to be transmitted to the base station is generated, transmitting, to the base station, a bandwidth request message for transmitting the generated data traffic to the base station through the primary carrier;
receiving, from the base station, a response message including secondary carrier information for transmitting uplink data traffic;
terminating the sleep window of the secondary carrier and changing the sleep window of the secondary carrier to thereby be identical to the sleep mode cycle of the primary carrier; and
transmitting the generated uplink data traffic through the primary carrier and secondary carrier.

11. The method of claim 10, wherein the instruction for terminating the listening window of the secondary carrier is received through a sleep control extended header.

12. The method of claim 10, wherein the secondary carrier information for transmitting uplink data traffic received from the base station is received through an unsolicited sleep response message including the secondary carrier index bit information, or sleep control extended header.

13. The method of claim 10, wherein the secondary carrier is a full configured carrier capable of transmitting and receiving data through downlink and uplink.

14. The method of claim 10, wherein the sleep mode cycle of the primary carrier is changed to a sleep mode cycle in which the listening window is newly started from a timing of transmitting the bandwidth request message.
